(19) United States
(12) Patent Application Publication
(10) Pub. No.: US 2008/0159515 A1
(43) Pub. Date: Jul. 3, 2008

(54) Communication system for remotely updating a registered user's status

(76) Inventor: Clark C. Rines, Mesa, AZ (US)

Correspondence Address: INTER-TEL (DELAWARE), INC.;A MITEL COMPANY, 7300 WEST BOSTON STREET, CHANDLER, AZ, 85226, US

(21) Appl. No.: 11/648,233

(22) Filed: Dec. 29, 2006

(51) Int. Cl. H04M 11/00

(52) U.S. Cl. 379/221.08

(57) ABSTRACT

A communication system for remotely updating a registered user's status allows the user to make status updates using a uniquely dialed number to a feature server of the system. The unique number corresponds to a particular status state that the user desires to be shared with others.

### FIELD OF INVENTION

The present invention relates generally to a communication system for remotely updating a registered user's status.

### BACKGROUND OF THE INVENTION

Providing solutions for determining a user's current status (e.g., busy, available, traveling, at home, etc.) is an ongoing problem in the communications industry, especially for mobile users. Maintaining contact with business associates and enterprise group members is typically accomplished by using a complex arrangement of call forwarding techniques. These are based on well-known direct user setup instructions regarding parameters like time of day, type of call, and other means to trigger diversion of call traffic to a desired termination point. Examples of communications products that support known call forwarding techniques include PABX endpoints, cell phones, PDAs equipped with telephone features, and network-connected computer processing applications. These products allow users to create complex patterns and rules so roaming users may be located and appropriately served with incoming calls and messages. As a consequence of this capability, the device routing rules are often times very complex and difficult to manage. Also, when users have access to such a wide variety of devices, the different call routing arrangements can be difficult to remember because of the wide variety of feature setup procedures and access codes.

In a communication system, it would be advantageous to trigger a change in status from a user's phone without having to interface to an IVR system or via a GUI from an IP computer. A traditional method would be to dial into a number and then navigate a menu via DTMF signaling or Automatic Speech Recognition (ASR). When driving in an automobile, ASR systems do not always function well due to background noise. Also, navigating a DTMF dial pad while listening to phone menus and also while driving is also awkward and dangerous. In addition, the user may be calling in from a phone which has pulse dialing and no DTMF is available.

It would be further advantageous for a user to indicate a status change from any communication device that the user is registered with, such as a cell phone, a PDA, a Wi-Fi enabled phone, a PSTN attached land line, or a digital or VoIP phone from within an enterprise. It would also be advantageous for the user to avoid lengthy audible system prompts to change a status. The latter function also would be advantageous to any user of the system that is deaf or hearing impaired.

### BRIEF DESCRIPTION OF THE DRAWINGS

Features, aspects, and advantages of the present invention may be best understood by reference to the following description taken in conjunction with the accompanying drawings, wherein like reference numerals indicate similar elements:

FIG. 1 illustrates a communication system suitable for remotely updating a registered user's status;

FIG. 2 illustrates, in block format, an exemplary feature server in accordance with the various embodiments;

FIG. 3 illustrates an exemplary administrator screen for mapping the numbers to dedicated user agents; and

FIG. 4 is a flow chart of exemplary operations of updating a registered user's status in accordance with the various embodiments.

### DETAILED DESCRIPTION

A communication system, in accordance with the various embodiments, for remotely updating a registered user's status includes designated network numbers to indicate the user's status. For example, a Direct Inward Dial (DID) number code may be established for each status state of the user. As each user calls the DID numbers, the user's caller-ID may be combined with the dialed DID number to indicate the status on an individual basis for each user.

Used herein, “status” is intended to mean a particular location, such as “at home” or “call office”, or particular event, such as “on vacation” or “at lunch”, or a particular routing rule, such as “send all incoming calls to mobile device.” Broadly defined, the “status state” is the user's availability and/or whereabouts to receive incoming communications.

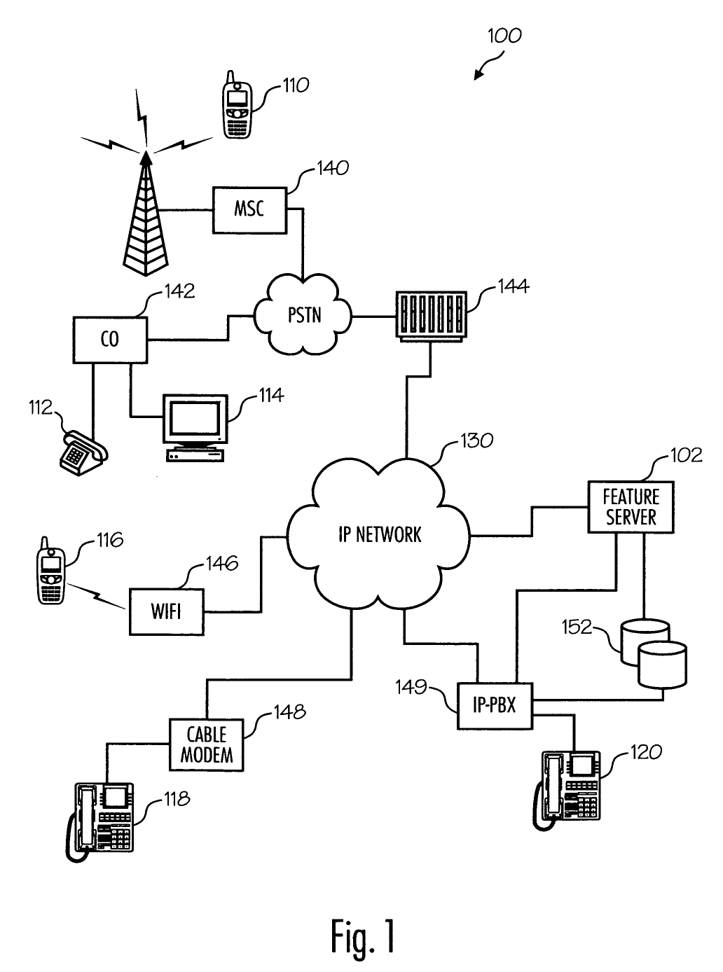

FIG. 1 illustrates a communication system 100 suitable for remotely updating a registered user's status. In general, system 100 includes a feature server 102, one or more endpoints 110-120, a database 152, and an IP network 130. Various gateways and the like, such as mobile switching center (MSC) 140, central office (CO) 142, IP gateway 144, WIFI access point 146, cable modem 148, and IP-PBX 149, enable communication between the different variety of endpoints and IP network 130. It should be appreciated that FIG. 1 is an exemplary schematic of various gateways and endpoints and is not intended to be limiting; rather, there may be many more types of endpoints and gateways that are suitable for use in system 100 or are understood in the industry as necessary for facilitating communications between the network. In addition, the details of the interconnects including, for example, firewalls, routers, and the SS7 network, are not shown in the Figure but are generally understood as common interfaces in a communication system.

Feature server 102 may be coupled to IP PBX 149 via a dedicated or IP connection. As will be discussed in more detail below, feature server 102 includes one or more user agents (UAs) each having their own unique number or code.

Database 152 stores information pertaining to the features, user's IDs, user's status, authentication, as well as other data for the system. Database 152 is coupled to feature server 102 and in some systems may be shared with IP-PBX 149.

The user may move about an enterprise or travel off-site and utilize other types of endpoints such as a WIFI phone (e.g., endpoint 116), a POTS phone (e.g., endpoint 112), a VoIP phone (e.g., endpoints 118, 120), or a cellular phone (e.g. endpoint 110). Regardless of the endpoint being used to update the user's status, the endpoint's communication will terminate at feature server 102 and to the user agents.

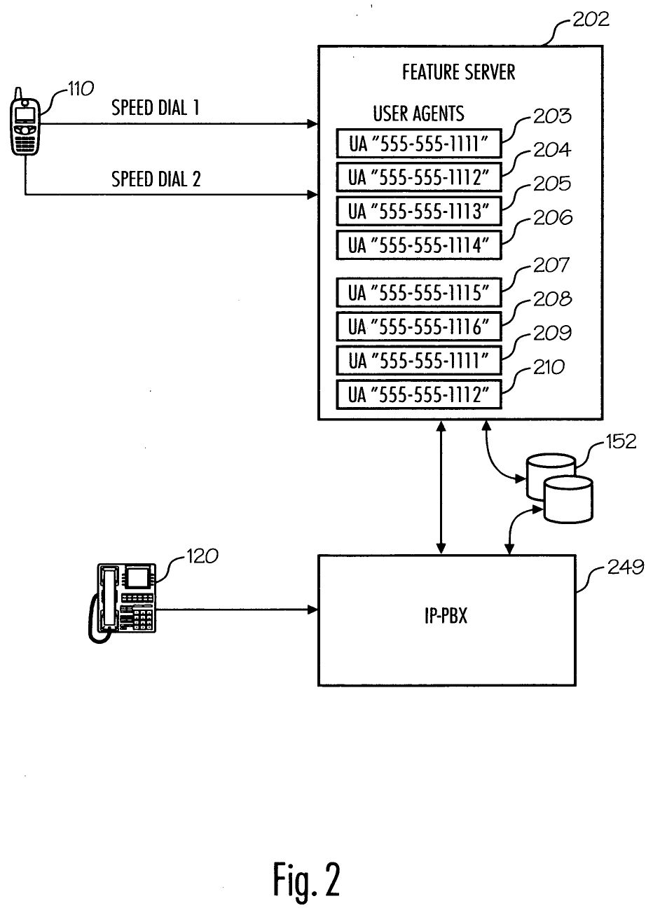

FIG. 2 illustrates, in block format, an exemplary feature server 202 in accordance with the various embodiments. Feature server 202 includes one or more user agents (UAs) 203-210 and is coupled to database 152. It should be realized that FIG. 2 depicts an office-like setting with feature server 202 coupled to IP-PBX 249, however the system is not so limited. Each UA corresponds to a unique number or code that identifies a particular status state for the user. For example, a unique telephone number may be dialed to update the user's status. The user is not required to listen to a voice response prompt, such as in a traditional IVR system where the user is prompted as part of a computer-driven dialogue for additional input. Rather, the user can update her status by simply calling a specific number corresponding to the status state desired.

In one aspect of the embodiment, the user may pre-program speed dial buttons on the endpoints to correspond to the UA unique numbers. For example, assume a registered user named “Diane” is driving in her car and she wishes to route calls arriving at her office phone 120 to her mobile phone 110. Diane had previously programmed a speed dial button on her mobile phone to correspond to the UA number for “route calls to mobile phone.” She conveniently depresses the speed dial button, e.g., “Speed Dial 1” on her mobile phone 110 as shown in FIG. 2, and she is connected to the appropriate UA in feature server 202. The feature is then activated and any incoming calls to office phone 120 will be routed to her mobile phone 110. Diane's feature selection is conveyed to IP-PBX 249 by a data link and IP-PBX 249 will detect her follow-me status when it looks at database 152 as calls are processed to her office telephone.

The routing rules are very flexible and Diane may wish for her office telephone to ring first at the office and if there is no answer, then to ring to her mobile phone. This may be useful in a shared-office space environment or if Diane has an assistant available to answer calls at the office.

When Diane arrives at home, she may depress a different speed dial button, e.g., “Speed Dial 2” on her mobile phone 110 as shown in FIG. 2, and this time the number or code dialed for the UA associated with “Speed Dial 2” changes her status state to “voice mail.” Now any calls coming to her office phone 120 will conveniently route to her voice mail.

Multiple UAs of the same name may exist in the feature server complex, see e.g., UA 203 and UA 209; UA 204 and UA 210. This allows for multiple users to call in and be processed simultaneously and also provides for redundancy in the system. When enabled, the system will select the first available UA if multiple calls occur simultaneously. Each of these UAs reside within the feature server complex but may be on different servers.

In another embodiment, the user, or administrator, registers the user's one or more endpoints with the system for security purposes. For example, the number associated with the user's endpoints is registered as belonging to the user. In this manner, the system authenticates the caller-ID information for registered endpoints as belonging to the user before proceeding with updating the user's status. If the caller-ID of the incoming call is not recognized by the system, the system may either optionally hang-up or indicate to the caller that the number/endpoint is not recognized, e.g., by audible tone or message. If a caller attempts to access the system with an invalid number, that number may optionally be logged for the administrator to review later. This allows for detection of invalid attempts to access the system.

Feature server 202 is also provided, via historical database records, with the called number that was called by any caller. For the arriving call, the server-supplied data pair {caller-ID:called-ID} is automatically available for storage in the database.

Database 152 maps every called-ID to a unique feature and state-value of that feature. When that number is called, the state associated with that feature is changed to the mapped called-ID state for that caller (represented by caller-ID). There may be a plurality of states for any feature in the system. Thus for every {caller-ID, called-ID} pair there is a unique feature call event. Table 1“Caller-ID Values” and Table 2“Called-ID Values” below help explain this.

TABLE 1
Caller-ID Values

| Number | User | User Line ID | Data Map |
|---|---|---|---|
| 602-555-5555 | Clark | “CLARK'S CELL” | <Auth User=”1.1”></> |
| 602-555-5556 | Clark | “CLARK'S OFFICE” | <Auth User=”1.1”></> |
| 602-555-5557 | Diane | “DIANE'S CELL” | <Auth User=”1.2”></> |
| 602-555-5558 | Diane | “DIANE'S OFFICE” | <Auth User=”1.2”></> |

TABLE 2
Called-ID Values

| Feature Index | Feature Value | Value Meaning | Data Map |
|---|---|---|---|
| 602-666-5000 | Presence | “AT WORK” | <PRESENCE state=”WORK”> |
| | | | <AUTH USER id= User> |
| | | | </> |
| 602-666-5001 | Presence | “AT HOME” | <PRESENCE state=”HOME-1”> |
| | | | <AUTH USER id= User> |
| | | | </> |
| 602-666-5002 | Presence | “AT LUNCH” | <PRESENCE state=”LUNCH”> |
| | | | <AUTH USER id= User> |
| | | | </> |
| 602-666-5003 | Presence | “NOT AVAILABLE” | <PRESENCE state=”DND”> |
| | | | <AUTH USER id= User> |
| | | | </> |
| 602-666-5004 | Presence | “ON VACATION” | <PRESENCE state=”WORK”> |
| | | | <AUTH USER id= User> |
| | | | </> |
| 602-666-5005 | Presence | “WORKING FROM | <PRESENCE state=”HOME-2”> |
| | | HOME” | <AUTH USER id= User> |
| | | | </> |
| 602-666-5006 | Presence | “CUSTOM AUDIO | <Message file |
| | | MSG” | play=”/MsgFile.wav”> |
| | | | <AUTH USER id= User> |
| | | | </> |
| 602-666-5007 | Home_Alarm | “ALARM OFF” | <ALARM state=”ON”> |
| | | | <AUTH USER id= User> |
| | | | </> |
| 602-666-5008 | Home_Alarm | “ALARM ON” | <ALARM state=”OFF”> |
| | | | <AUTH USER id= User> |
| | | | </> |

For this example, assume a registered user named “Clark” is at work. He dials “602-666-5001” from his cell phone, which has a caller-ID of “602-555-5555”, and the system first verifies that Clark's cell phone is a valid number and then changes Clark's status to “AT HOME”, which from Table 2, corresponds to the number Clark dialed. Clark later dials “602-666-5002” from his office phone, which has a caller-ID of “602-555-5556”. Upon verification of the caller-ID, Clark's status would be changed to “AT LUNCH”(see, Table 2). It is not necessary for Clark to remain on the line to hear the system answer the call. Rather, the system must simply be alerted long enough for the caller-ID, called-ID data to be collected.

As we will see, this functionality can be extended for call back functionality as well as allowing specific DNs to actually answer. This is shown in the case of a custom “Presence” value for “602-666-5006” on Table 2. If the user dials this number, the user may leave a brief audio message. The custom message may be played back when the user's presence is queried or if user's endpoint is called and the user has selected the custom message as a personal greeting. An example would be, “I am traveling on business, please leave a message and I will get back to you as soon as possible.”

It should be realized that instead of a plurality of individual UAs, as is shown in FIG. 2, a single UA may accept the call, parse and act on the caller-ID and called-ID of the incoming call. Based on the {caller-ID; called-ID} pair, the appropriate feature can be invoked. This may be, for instance, changing the presence status of the caller. The actual handling of the information may be handled within this single UA or it may be handed off to one or more server applications resident on the same or additional servers to process the information. Such an implementation may reduce the real time requirements of having a plurality of UAs all concurrently running on one server.

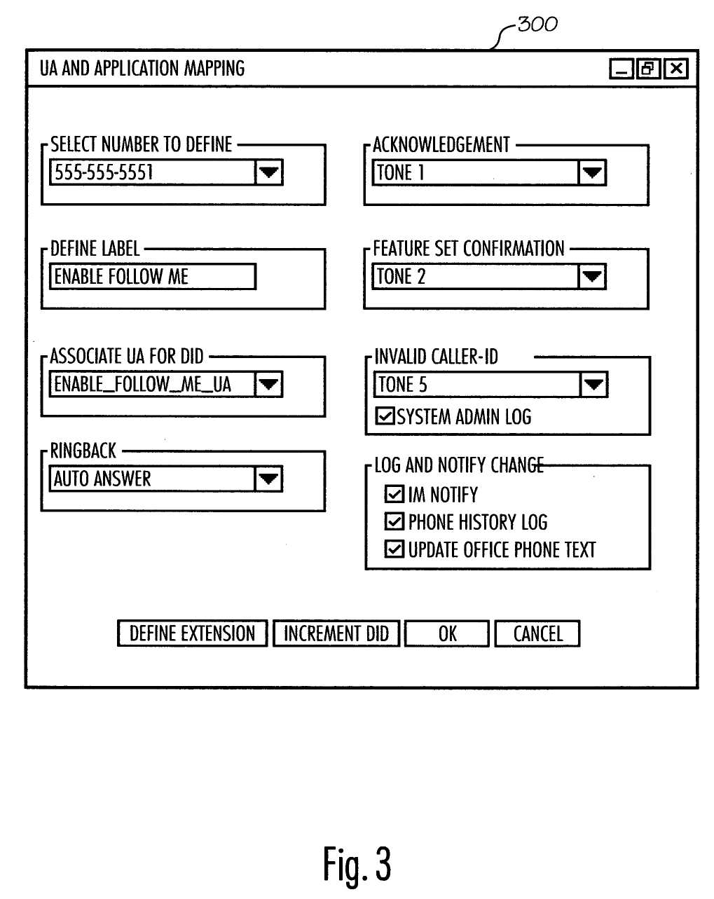

FIG. 3 illustrates an exemplary administrator screen 300 for mapping the numbers to dedicated UAs. The administrator may first enter the DID number using the pull-down box shown in the upper left. Then the particular status to be associated with the number is selected. The UA provides one function for every particular number which is dialed. In this example, the number “555-555-5551” is mapped to the UA that enables a “Follow Me” feature for the user. Once the entire mapping is complete, the administrator may conveniently depress the “Define Extension” button which will cause a small dialog box to pop up. The administrator may then easily define an internal extension to map to the same DID functionality. In this example, the administrator may simply type in a number like “5551”; thus, when internal enterprise callers use the system, they dial 5551, rather than the full DID number used for the external feature mapping. Once a number is defined, the administrator/user may conveniently define a text label to associate with the feature. This label is for the user's convenience and may also be used for logging functions. Once an administrative entry has been confirmed, the system maps the predefined UA to the number.

In one embodiment, the system may include one or more audible tones to alert the caller to specific events. For example, an optional acknowledgement tone may be heard by the caller to indicate the system has answered the call. In general, the system may be set up so that once the caller-ID is recognized, the user may hang up so there is no requirement that the user stay on line. A different optional confirmation tone may be heard to indicate the user's status has been updated. So in the first example, user, Diane, may depress a speed dial button from her cell phone and hang up, or she may wait for the acknowledgement tone and the confirmation tone. The system may also log the call and transmit a notification of acknowledgement such as, an instant message to the user's endpoint or a message to the user's call log.

For administrators needing to define a large block of DID numbers, a convenient feature may be provided that increments the DID number being programmed and saves the previous data. This button is shown as “Increment DID” on FIG. 3. This feature will conveniently cause the DID number to increment one digit (e.g., 555-555-5551 to 555-555-5552) and automatically save any programming completed for previous number.

Additional details regarding the various elements and operation of a system for remotely updating a registered user's status will be described in the following flowchart and accompanying text. The flowchart is provided to better understand the various steps of operation in updating the user's status in accordance with the various embodiments. It should be realized that the following description is not intended to be limiting but rather to provide a description of various embodiments and a best mode of operation. It should be appreciated that additional steps may occur that are not represented on the flowcharts but are discussed in the conjoining text or elsewhere herein. Moreover, there may be operations, functions, routines, and the like that are not depicted on the flowchart or elsewhere but are well understood in the industry as common actions for an endpoint and/or communications system. Unless specifically stated, the order of the depicted and described operations are not limited to the conjoining description.

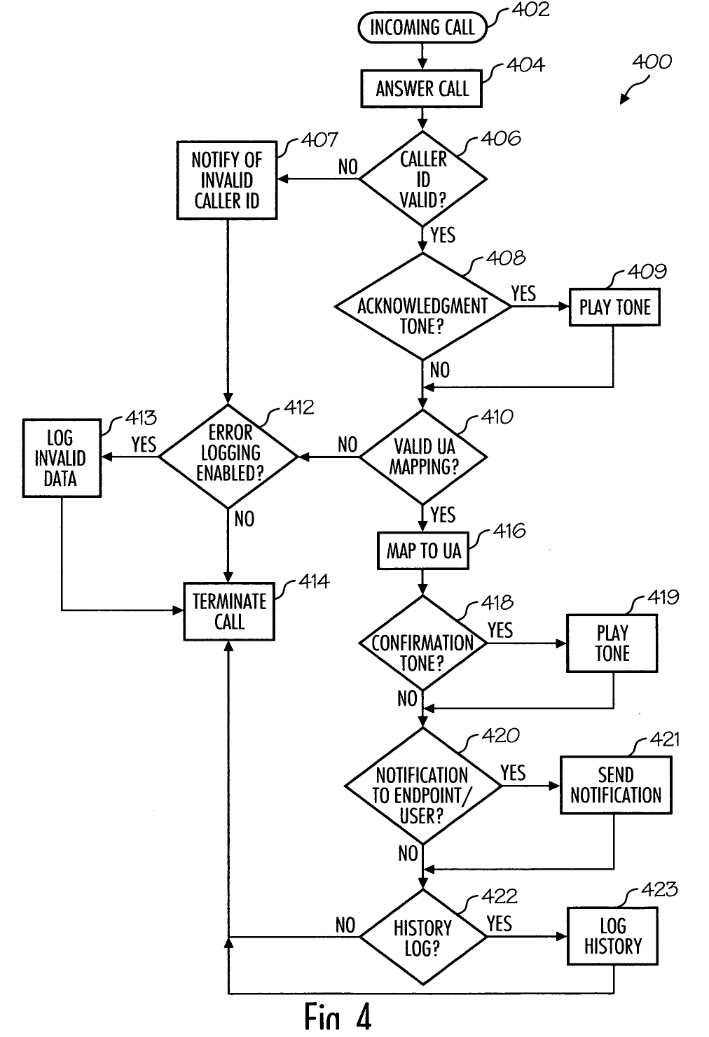

FIG. 4 is a flow chart 400 of exemplary operations of updating a registered user's status in accordance with the various embodiments. Initially, the system recognizes an incoming call (step 402) and answers the call (step 404). The call may be packet-based or from the PSTN. In both cases, the call data, including caller-ID information, is included with the call notification. The calling/called codes used to indicate user identities are not limited to numbers but may be represented by any string, language, or symbol that that is appropriate for the application. Alternatively, (although not depicted on the flow) the system may first determine if the incoming call is originating from outside the local IP-PBX. This can be determined by examining the caller-ID passed to the system. In yet another embodiment, the system may look at the ring-back settings as administrated in FIG. 3. If the setting is “Auto Answer”, then the call will be answered without any tone or message being played to the caller. If a specific tone or message has been set, then that message or tone is played to the incoming caller.

The system determines if the caller-ID of the incoming call is valid, e.g., registered to user and/or UA, (step 406). If the caller-ID is not recognized as being valid, the user is notified by, for example, a tone, a message or a hang up (step 407). If the caller-ID is valid, then the system determines if an acknowledgement tone has been set (step 408). The acknowledgement field may be “None” or a “Specific Tone” as described on FIG. 3 and the accompanying text. If the acknowledgement field is set to a tone, then the tone is played to the user (step 409), otherwise, no tone may be heard.

The system next determines if the called number is mapped to a valid UA (step 410). If the number is not mapped to a valid UA or for whatever reason the system is unable to complete the desired status update (e.g., the server containing the UA is down), then the system determines if the error logging feature has been enabled (step 412). If so, then the error is logged (step 413) and the call is ended (step 414). In addition, an invalid tone or message may be played to the user (not shown).

If the incoming call is mapped to an UA, then the system updates the user's status according to the corresponding UA (step 416). As was previously discussed, there may be multiple UAs providing the same functionality on a plurality of servers.

The preceding step selects an available UA and passes the call on to it. At this point as well, that UA will act on the user's request as determined by the called number, such as turn a feature off or on, play back status information, or execute a plurality of steps which have been pre-defined and are embodied within the UA.

The system then determines if the confirmation tone feature is enabled (step 418) and if so, the tone is played (step 419). Other notification features may also be enabled. For example, the system may determine if a notification is to be sent to the user's endpoint (e.g., an instant message or other visual or audio indication) (step 420), and if so, notification is sent (step 421). Finally, the system determines if the feature changes are to be logged (step 422). If the history is to be logged, then the data may be written to the common database (step 423). This log may be available to the user through their endpoints, which are attached to the IP-PBX, as well as any other client application that can access that database. At this point, the call is terminated and the UA is available to accept another call (step 414).

In another embodiment, the remote update to the user's status may be an IM message with the DID number embedded within the IM message. The address from which the IM message is sent may be used to determine the caller and verification instead of called-ID. This embodiment permits the user to send an IM message from a text enabled endpoint (e.g., PDA, cell phone or similar device) and accomplish the same functionality as dialing a phone number. The ability to dial an IP or PSTN based number allows for great flexibility to the user.

Presented herein are various embodiments, systems, methods and techniques, including a best mode, for remotely updating a registered user's status. Having read this disclosure, one skilled in the industry may contemplate other similar methods, techniques, modifications, arrangements, and components for such a system that falls within the scope of the present invention. These and other changes or modifications are intended to be included within the scope of the invention, as expressed in the following claims.

1. A system for remotely updated a user's status comprising:
a feature server having one or more user agents, the user agents having a unique number that identifies a particular status state for the user, the status state is shared with other users of the system when communication with the user is desired;
a database coupled to the feature server for storing data pertaining to the user's status; and
an endpoint registered with to the user and a registration stored in the database; wherein, upon connection between the endpoint and the feature server of the unique number, the feature server verifies the registration and updates the status state for the user to correspond to the particular status state of the unique number.
